(19) United States
(12) Patent Application Publication
(10) Pub. No.: US 2025/0030207 A1
(43) Pub. Date: Jan. 23, 2025

(54) AUDIO CABLE CONNECTOR WITH SELECTABLE IMPEDANCE

(71) Applicant: Atlantic Signal, LLC, Topeka, KS (US)

(72) Inventors: Cody Michael Stallbaumer, Topeka, KS (US); David J. Bondarenko, Topeka, KS (US)

(73) Assignee: Atlantic Signal, LLC, Topeka, KS (US)

(21) Appl. No.: 18/775,363

(22) Filed: Jul. 17, 2024

Related U.S. Application Data
(60) Provisional application No. 63/514,454, filed on Jul. 19, 2023.

(51) Int. Cl. H01R 13/70; H01R 13/6473; H04R 3/00

(52) U.S. Cl. CPC H01R 13/70; H01R 13/6473; H04R 3/00

(57) ABSTRACT

An audio cable connector with selectable impedance includes low impedance interface circuitry and high impedance interface circuitry, and a user-operable switch to allow a user to select either of the two impedances to connect to a headset microphone. With the audio cable connector in communication between a headset and equipment, the user may select the appropriate impedance interface circuitry to allow the headset to operate properly with the equipment.

### CROSS-REFERENCE TO RELATED APPLICATIONS

This application claims the benefit of U.S. Provisional Patent Application No. 63/514,454, filed Jul. 19, 2023, the disclosure of which is hereby incorporated herein in its entirety by reference.

### BACKGROUND

Audio communication equipment is used to facilitate communication between two or more people, or between multiple people within a group. The communication equipment is often facilitated in conjunction with headsets having speakers, earphones or earbuds to allow a user to hear other people and microphones to allow a user to talk to others, with various interface circuitry and controls built in to the headsets to allow a user to control and operate the audio equipment. For example, a communications headset may include a push-to-talk (PTT) switch to allow a user's microphone to remain silent unless the PTT switch is pressed, or may include a mute switch to temporarily silence the speakers/earphones/earbuds.

Most U.S. military audio communication equipment employs a common audio plug/audio jack combination to allow connection of any compatible headset, such as a 3.5 mm or ⅛ inch multiple conductor plug/jack. For example, a headset usable with a particular military radio is generally compatible with any other military radio, and is also generally compatible with on-board communications systems in military vehicles. Thus, a user carrying a military compatible communication headset is able to use that same headset with various military radios and with the communication system in various military vehicles.

Similarly, most U.S. civilian audio communication equipment-including law enforcement communication equipment-employs a common audio plug/audio jack combination to allow connection of any compatible headset, such as a 3.5 mm or ⅛ inch multiple conductor plug/jack so that a headset usable with a particular civilian radio is generally compatible with any other civilian radio, and is also generally compatible with on-board communications systems in civilian vehicles, such as police and fire emergency vehicles. Thus, a user carrying a civilian compatible communication headset is able to use that same headset with various military radios and with the communication system in various military vehicles.

However, while the military and civilian communication systems are common in many aspects, and allow compatibility within the respective system (i.e., military or civilian), the two systems are not compatible with each other and equipment compatible with one system will not operate correctly on the other system. Most military communication equipment uses low-impedance circuitry to interface with the low-impedance headsets while most civilian communication equipment uses high-impedance circuitry to interface with the high-impedance headsets. Thus, the two varying systems (low-impedance vs. high-impedance) are not compatible and headsets and other equipment usable on one system does not operate properly on the other system.

In order to avoid issues with incompatible equipment, users that may encounter both low-impedance and high-impedance systems must carry two separate headsets so that are ready and able to communicate on any system they encounter. For example, each member of a military unit transferring to a civilian aircraft or vehicle must carry a low-impedance headset for use on the military equipment and must carry a high-impedance headset for use on the civilian equipment.

Thus, it can be seen that there remains a need in the art for an improved communication device that overcomes the shortcomings of current systems and technology.

### SUMMARY

Embodiments of the invention are defined by the claims below, not this summary. A high-level overview of various aspects of the invention is provided here to introduce a selection of concepts that are further described in the detailed description section below. This summary is not intended to identify key features or essential features of the claimed subject matter, nor is it intended to be used in isolation to determine the scope of the claimed subject matter. In brief, this disclosure describes an audio cable connector with internal circuitry that allows a user to configure the audio cable as either a high-impedance or a low-impedance device, thus allowing use of a headset having speakers/earphones and a microphone with either high-impedance or a low-impedance systems or equipment.

In one embodiment, the interface circuitry is encased within an audio cable extending from a headset device having speakers/earphones and a microphone, with a plug on the end of the audio cable configured to plug in to a corresponding communications socket or receptacle. A switch on the audio cable may be actuated by a user to switch between high-impedance and low-impedance modes as desired to match the headset to the corresponding impedance of the system or device being used.

In a further embodiment, the interface circuitry may be encased within an adapter module having an input jack for plugging in a headset, an output cable with a plug for plugging into a device (e.g. a radio) or system (e.g., an intercom system in a vehicle), with a switch on the adapter module allowing a user to select between high-impedance and low-impedance to match the system/device being connected to.

In some embodiments, the switch position may further provide a visual indication of the selected high or low impedance configuration, in other embodiments a visual indicator, such as an LED, may provide an indication of the selected impedance mode.

### DESCRIPTION OF THE DRAWINGS

Illustrative embodiments of the invention are described in detail below with reference to the attached drawing figures, and wherein:

FIG. 1 is top perspective view of an audio cable connector with selectable impedance in accordance with an exemplary embodiment of the present invention.

FIG. 2 is a bottom perspective view of the audio cable connector with selectable impedance of FIG. 1.

FIG. 3 is a is a bottom plan view of the audio cable connector with selectable impedance of FIG. 1.

FIG. 4 is a top plan view of the audio cable connector with selectable impedance of FIG. 1.

FIG. 5 is a left plan view of the audio cable connector with selectable impedance of FIG. 1.

FIG. 6 is a right plan view of the audio cable connector with selectable impedance of FIG. 1.

FIG. 7 is a left end view of the audio cable connector with selectable impedance of FIG. 1.

FIG. 8 is a right end view of the audio cable connector with selectable impedance of FIG. 1.

FIGS. 9A and 9B depict a schematic diagram of an audio cable connector with selectable impedance in accordance with an exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

Embodiments of the invention include an audio cable connector with selectable impedance allowing a user to select a high or low impedance configuration to match the impedance of equipment to which the audio cable connector is being connected. Various embodiments may employ various combinations of elements and components for achieving the selected impedance.

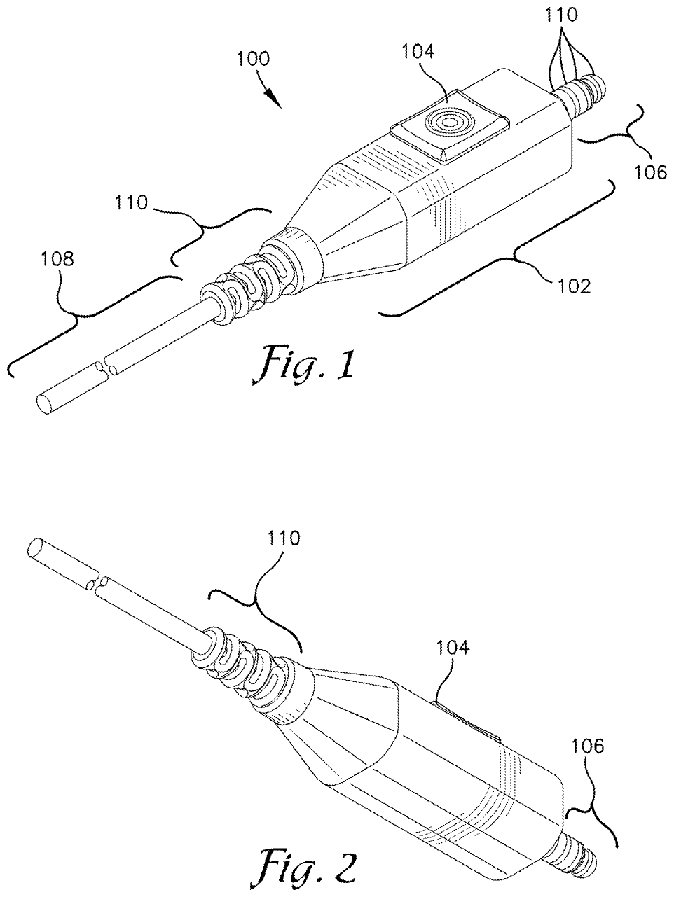

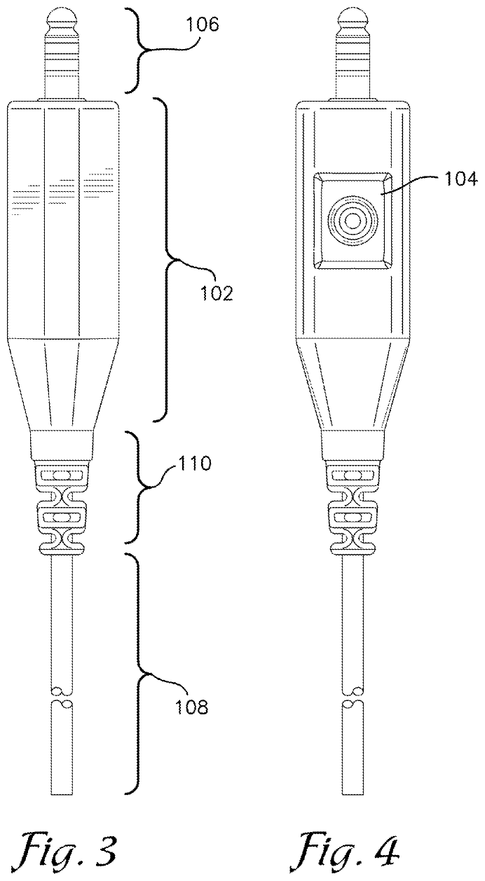

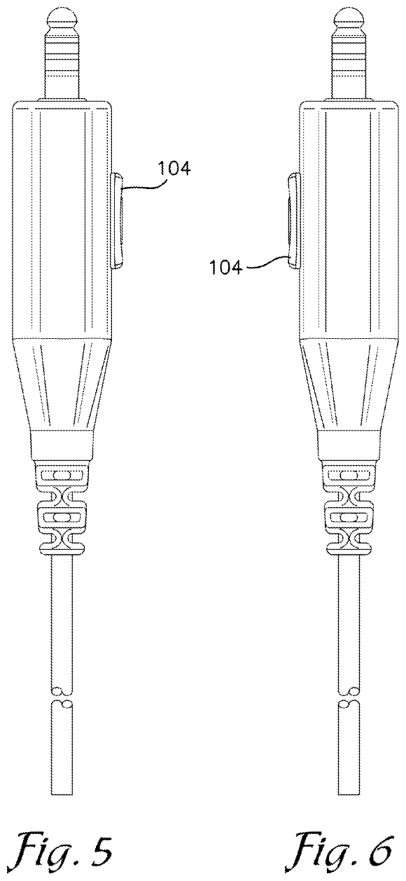

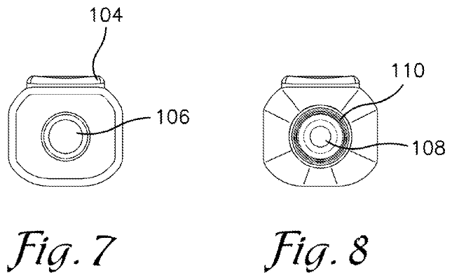

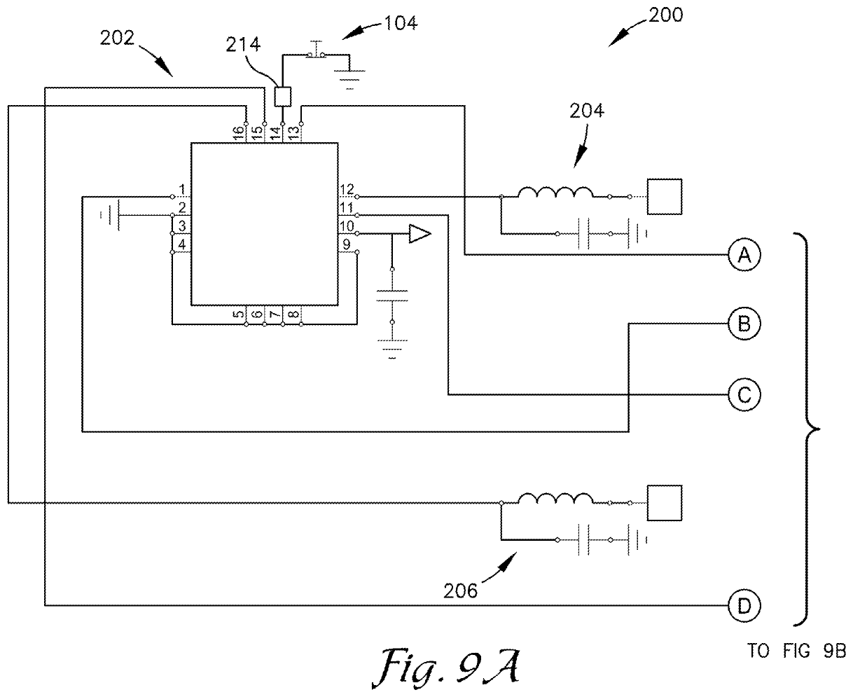

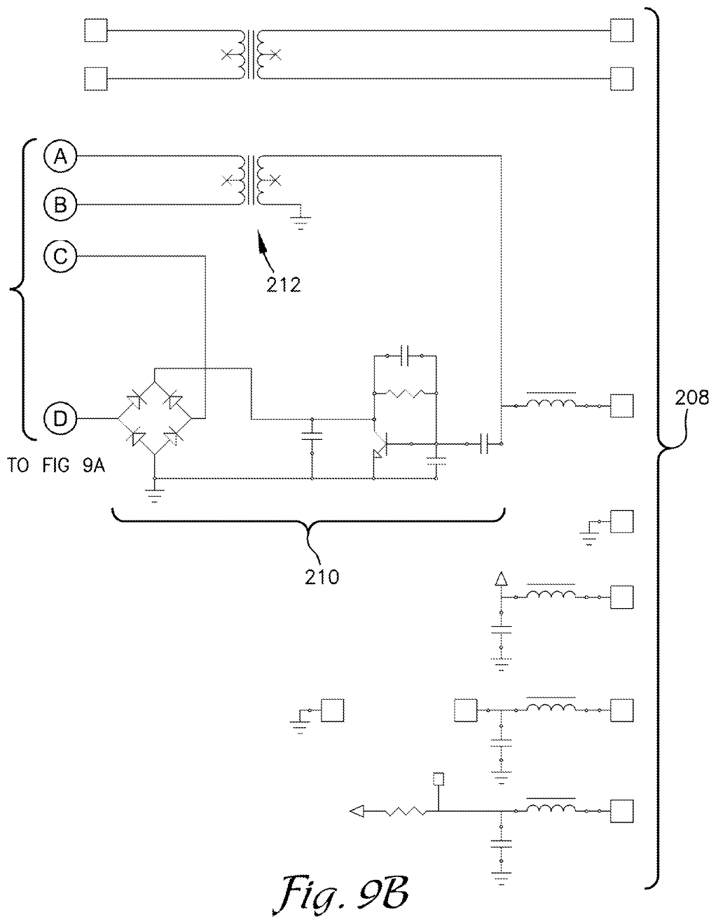

FIGS. 1 through 8 depict various views of an exemplary physical configuration of an audio cable connector with selectable impedance in accordance with the present invention and FIGS. 9A and 9B depict a schematic diagram of an exemplary embodiment of the logic and control circuitry contained within the audio cable connector.

Looking to FIGS. 1 through 8 in conjunction, an audio cable connector with selectable impedance in accordance with an exemplary embodiment of the present invention is depicted generally as numeral 100. The audio cable connector 100 includes a housing 102 encapsulating logic and control circuitry (as is described in more detail below), with a user-actuated switch 104 positioned and accessible on the top of the housing 102. A plug 106 extends outwardly from one end of the housing 102, with a cable 108 entering the housing 102 on the end opposite the plug 106. Cable 108 passes through a strain relief 110 as it joins the housing 102, the strain relief 110 supports and protects the cable 108 (and the individual wires within the cable) from damage as the cable 108 flexes during use.

Plug 106 comprises a plurality of cylindrical conductors 110 separated by insulating material, with each conductor 110 typically carrying a separate electrical signal for propagating audio and/or control signals to the equipment to which the plug is connected to.

In a typical embodiment, the cable portion 108 of the audio cable connector 100 attaches to a communications headset which comprises: speakers or other audio transducers that provide audible communications to a wearer; a microphone which allows the wearer to communicate with others; and a switch such as a push-to-talk (PTT) which allows the wearer to control equipment to which the headset is connected.

The audio and control signals emanating from and/or passing into the communications headset pass through individual wires comprising cable 108 and through the logic and control circuitry contained within the housing 102. The individual wires of cable 108 connect to a corresponding one of the cylindrical conductors 110 of plug 106 such that communication signals (i.e., audio and/or control signals) pass to/from the communications headset, through the logic and control circuitry contained in the housing 102, and to the plug 106.

With the plug 106 inserted into the headset/microphone jack of a communications device such as a communications radio, the communications headset is thus in electrical communication with the device, with the audio cable connector 100 positioned in-line between the communications headset and the communications radio (or other devices).

It should be understood that cable 108 may attach to the communications headset either directly, i.e., such that the cable 108 and audio cable connector 100 are integral and hardwired to the communications headset, or that cable 108 may attach to an audio jack, with the audio jack allowing an off-the-shelf communications headset to plug directly into cable 108. In either case, with the communications headset either hardwired to cable 108 or plugged into a jack on cable 108, audio and/or control signals from the communications headset ultimately pass through cable 108 and through the logic and control circuitry contained within the housing 102, and to plug 106 which is plugged into the communications device.

With the audio and/or control signals passing through the audio cable connector 100, a user may match the impedance of the communications headset to the impedance of the communications device by actuating switch 104. Switch 104 is operatively connected to the logic and control circuitry 200 as depicted in FIGS. 9A and 9B, allowing a user to select a desired impedance by pressing or otherwise actuating switch 104.

Turning now to FIGS. 9A and 9B, a schematic diagram of the logic and control circuitry of the audio cable connector 100 with selectable impedance in accordance with an exemplary embodiment of the present invention is depicted generally by the numeral 200.

As described above, the audio cable connector with selectable impedance allows a user to select an appropriate impedance (e.g., high or low) to match a particular communications headset/microphone to a particular piece of communications equipment to allow the headset to properly match the impedance of the device it is plugged in to.

As depicted in FIGS. 9A and 9B, in one exemplary embodiment of the present invention, the logic and control circuitry 200 includes an analog switching component 202, such as a DG2788A low capacitance dual double-pole, double throw (DPDT) analog switch integrated circuit. The analog switching component 202 allows switching of + and microphone and/or speaker inputs to different impedance loads 204, 206 to allow matching high or low impedance equipment to the headset/microphone being used.

Switch 104 is connected to a control input pin 214 of the analog switch component 202 so that actuation of switch 104 by a user causes the analog switch component to toggle between first and second states, connecting either high or low impedance circuitry through which signals traveling on cable 108 pass. Thus, by actuating switch 104 a user can select between either high impedance 204 or low impedance 206 circuitry in order to match the impedances of the communications headset and communications device being used.

As seen in the figure, actuation of the control input 214 by switch 104 actuates the analog switch component 202 to switch the microphone − and + inputs) to either high 204 or low impedance 206 circuitry, thus, a user can operate a switch 104 (as described above) to actuate the analog switch to invoke the desired impedance matching circuitry.

Switch 104 is preferably a normally open or a normally closed push button switch which provides an electrical signal to the control input 214 to cause the analog switch component to toggle between first and second inputs—i.e., to connect either high impedance or low impedance matching circuitry. In alternative embodiments, other types of switches, such as mechanical toggle switches, may be used to connect the desired impedance matching circuitry

It should be understood that in other embodiments additional analog switch components may be included in the logic and control circuitry to allow switching of more than two impedances, e.g., the control circuitry may be configured such that the switch 104 switches between first, second, and third impedances (high, medium, and low). These and other configurations are within the scope of the present invention.

As depicted, high and low impedance banks 204 and 206 preferably include combinations of inductors and capacitors to provide a desired impedance.

Finally, as depicted by 208 in the figure, various push to talk signal inputs and outputs are available for connection of additional audio and/or control signals through the logic and control circuitry 200. For example, various transformers 212 and rectifier circuitry 210 may provide power to the analog switch component 202 and/or to provide power to the communications headset.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. An audio cable connector with selectable impedance, comprising:
a cable comprising a plurality of wires configured to connect to a communications headset;
a plug configured to connect to a communications device;
a housing configured to contain logic and control circuitry;
logic and control circuitry positioned within the housing and operable to receive input from a user and to connect impedance matching circuitry between a microphone input from the cable and the plug, the logic and control circuitry comprising:
first impedance matching circuitry comprising a low impedance interface;
second impedance matching circuitry comprising a high impedance interface; and
a switch operable to cause the logic and control circuitry to select one of the first impedance matching circuitry or the second impedance matching circuitry for connection to the microphone input upon actuation of the switch by a user.

2. The audio cable connector of claim 1, wherein the switch comprises a push button switch positioned within and protruding from the housing such that it is operable by a user.

3. The audio cable connector of claim 1, wherein the logic and control circuitry further comprises impedance matching circuitry for a loudspeaker of the communications headset.

4. The audio cable connector of claim 1, wherein each of the first impedance matching circuitry and the second impedance matching circuitry comprise: inductors, capacitors, or combinations thereof.

5. The audio cable connector of claim 1, wherein the logic and control circuitry comprises an analog switching component actuated by the switch.

6. The audio cable connector of claim 1, wherein the logic and control circuitry further comprises power supply circuitry.

7. The audio cable connector of claim 1, wherein the plug comprises a plurality of conductors separated by a plurality of insulators.

8. An audio cable connector with selectable impedance, comprising:
a cable comprising a plurality of wires configured to connect to a communications headset;
a plug configured to connect to a communications device;
a housing configured to contain logic and control circuitry;
logic and control circuitry positioned within the housing and operable to receive input from a user and to connect impedance matching circuitry between a microphone input from the cable and the plug, the logic and control circuitry comprising:
a plurality of impedance matching circuits;
a switch operable to cause the logic and control circuitry to select a desired one of the plurality of impedance matching circuits for connection to the microphone input upon actuation of the switch by a user.

9. The audio cable connector of claim 8, wherein the switch comprises a push button switch positioned within and protruding from the housing such that it is operable by a user.

10. The audio cable connector of claim 8, wherein the logic and control circuitry further comprises impedance matching circuitry for one or more loudspeakers of the communications headset.

11. The audio cable connector of claim 8, wherein each of the first impedance matching circuitry and the second impedance matching circuitry comprise: inductors, capacitors, or combinations thereof.

12. The audio cable connector of claim 8, wherein the logic and control circuitry comprises a plurality of analog switching components each actuated by the switch.

13. The audio cable connector of claim 8, wherein the logic and control circuitry further comprises power supply circuitry.

14. The audio cable connector of claim 8, wherein the plug comprises a plurality of conductors separated by a plurality of insulators.

15. An audio cable connector with selectable impedance, comprising:
a cable comprising a plurality of wires configured to connect to a communications headset;
a plug configured to connect to a communications device, the plug comprising a plurality of conductors each in communication with a corresponding one of the plurality of wires;
a housing configured to contain logic and control circuitry;
logic and control circuitry positioned within the housing and operable to receive input from a user and to connect impedance matching circuitry between an input from at least one of the plurality of wires of the cable and one of the plurality of conductors of the plug;
first impedance matching circuitry comprising a low impedance interface; second impedance matching circuitry comprising a high impedance interface; and
a switch operable to cause the logic and control circuitry to select one of the first impedance matching circuitry or the second impedance matching circuitry for connection to the input from at least one the plurality of wires upon actuation of the switch by a user.

16. The audio cable connector of claim 15, wherein the switch comprises a push button switch positioned within and protruding from the housing such that it is operable by a user.

17. The audio cable connector of claim 15, wherein the logic and control circuitry further comprises impedance matching circuitry for a loudspeaker of the communications headset.

18. The audio cable connector of claim 15, wherein each of the first impedance matching circuitry and the second impedance matching circuitry comprise: inductors, capacitors, or combinations thereof.

19. The audio cable connector of claim 15 wherein the logic and control circuitry comprises an analog switching component actuated by the switch.

20. The audio cable connector of claim 15 wherein the logic and control circuitry further comprises power supply circuitry.
